(19) United States
(12) Patent Application Publication
(10) Pub. No.: US 2012/0050835 A1
(43) Pub. Date: Mar. 1, 2012

(54) OPTICAL SCANNING DEVICE AND IMAGE FORMATION APPARATUS

(75) Inventors: Yoshitaka Otani, Toyokawa-shi (JP); Hajime Taniguchi, Toyokawa-shi (JP); Hidenari Tachibe, Toyokawa-shi (JP); Takafumi Yuasa, Toyokawa-shi (JP)

(73) Assignee: Konica Minolta Business Technologies, Inc., Tokyo (JP)

(21) Appl. No.: 13/224,042

(22) Filed: Sep. 1, 2011

(30) Foreign Application Priority Data
Sep. 1, 2010 (JP) 2010-195694

(51) Int. Cl. G02B 26/10

(52) U.S. Cl. 359/204.1

(57) ABSTRACT

An optical scanning device in which optical beams from a light-emitting element are passed through a collimator lens and are deflected by a deflector and which scans over an image carrier by using the deflected optical beams, comprising: a device housing; and a holder supported on a base of the housing so as to be rotatable about an optical axis of the collimator lens, and penetrating through a through-hole in a side wall of the housing along the optical axis without contacting the side wall, wherein the holder includes first and second holder parts, the first holder part located inside the housing, and the second holder part located outside the housing, the collimator lens is held by the first holder part, the light-emitting element is held by the second holder part, and the optical beams pass through the through-hole in the side wall and reach the collimator lens.

This application is based on application No. 2010-195694 filed in Japan, the contents of which are hereby incorporated by reference.

### BACKGROUND OF THE INVENTION

(1) Field of the Invention

The present invention relates to an optical scanning device in which a plurality of optical beams are deflected by a deflector, and which scans over an image carrier of an image formation apparatus. The present invention also relates to an image formation apparatus having the optical scanning device. In particular, the present invention relates to a technology for moderating fluctuations in beam pitch of the plurality of optical beams in the vertical scanning direction, which are caused by environmental changes.

(2) Related Art

Conventionally, image formation apparatuses having an optical scanning device that uses a plurality of laser beams have been developed. In such an image formation apparatus, n (plural) laser beams, which are emitted from n light emission points of a single semiconductor laser, are deflected by a reflective surface of a rotating polygon mirror in the optical scanning device, and the optical scanning device scans over a single image carrier (e.g. photosensitive drum) via a scanning lens or the like by using the n laser beams simultaneously, and thus forms an electrostatic latent image on the image carrier.

In such an optical scanning device, n laser beams are deflected by a single reflective surface of a polygon mirror, and hence the optical scanning device is capable of forming an electrostatic latent image on the image carrier n times faster than devices using only one laser beam. Thus, the time required for image formation is reduced, and this greatly improves the productivity relating to the image formation.

Japanese Patent Application Publication No. 2000-98285 discloses an optical scanning device in which a light source unit, including a lens barrel, a semiconductor laser attached to one end of the lens barrel, and a collimator lens attached to the other end of the lens barrel, is fit in a round hole provided in a side wall of the housing of the device, so as to be rotatable about the optical axis of the collimator lens.

The lens barrel is rotated about the optical axis of the collimator lens, and accordingly the semiconductor laser is rotated about the optical axis. Thus, in regard to two laser beams emitted from the semiconductor laser, the distance (beam pitch) therebetween on the image carrier in the vertical scanning direction can be adjusted to a predetermine distance. The predetermined distance is, for example, about 42 μm when the resolution is 600 dpi. After the adjustment, the lens barrel is fixed to the side wall of the device with a screw, in order to prevent the lens barrel from being displaced in the rotation direction.

When a structure in which a light source unit is fit in a side wall of the housing of the device is adopted as with patent application Publication mentioned above, there is a problem that the beam pitch tends to fluctuate due to environmental changes around the device.

That is, when the environment around the device changes, specifically when the temperature and humidity change, the device housing, made from a resin, a metal and the likes, would be slightly deformed. In particular, the side wall of the device housing tends to incline from the original vertical position with respect to the base thereof, and to be in an inclined position. When the side wall assumes the inclined position, the lens barrel inclines as well as the side wall. Consequently, the light paths of the two laser beams from the light source unit are displaced from their original positions.

When the light paths of the two laser beams are displaced, the beam pitch between the two laser beams on the image carrier changes from the original beam pitch (about 42 μm in the example above) by an amount corresponding to the displacement.

For example, if the beam pitch between the two laser beams becomes narrower than the original pitch, the beam pitch between scan lines L1 and L2 of the two laser beams, which are deflected by a first reflective surface of the polygon mirror and both scan over the image carrier simultaneously, becomes narrower than its original pitch. Similarly, the beam pitch between scan lines L3 and L4 of the two laser beams, which are deflected by a second reflective surface of the polygon mirror and both scan over the image carrier simultaneously, becomes narrower than its original pitch.

However, the rotation speed of the polygon mirror is constant, and thus the beam pitch between the scan lines L2 and L3 becomes wider than the original pitch. Consequently, the beam pitches between L1 and L2, between L2 and between L3, and L3 and L4 vary from each other. When the beam pitch becomes wider than the original pitch, the beam pitches between the scan lines vary in the similar manner.

Such fluctuations in beam pitch change the scanning positions of the electrostatic latent image on the image carrier for each of the scan lines. This could be a cause of deterioration of the quality of reproduced images.

### SUMMARY OF THE INVENTION

The aim of the present invention is to provide an optical scanning device in which a plurality of optical beams from a light-emitting element are deflected by a deflector and are used for scanning over an image carrier of an image formation apparatus, and which is capable of preventing image quality deterioration due to fluctuations in beam pitch caused by environmental changes, and to provide an image formation apparatus having the same.

The aim is achieved by an optical scanning device in which a plurality of optical beams from a light-emitting element are passed through a collimator lens, are thereby collimated, and are then deflected by a deflector, and which scans over an image carrier of an image formation apparatus by using the plurality of deflected optical beams, the optical scanning device comprising: a device housing; and a holder supported on a base of the device housing so as to be rotatable about an optical axis of the collimator lens, and penetrating through a through-hole in a side wall of the device housing in a direction along the optical axis without contacting the side wall, wherein the holder includes a first holder part and a second holder part, the first holder part being located inside the device housing with respect to the side wall, and the second holder part being located outside the device housing with respect to the side wall, the collimator lens is held by the first holder part, and the light-emitting element is held by the second holder part, and the optical beams from the light-emitting element pass through the through-hole in the side wall, and reach the collimator lens.

The aim is also achieved by an image formation apparatus having the optical scanning device defined above.

### BRIEF DESCRIPTION OF THE DRAWINGS

These and other objects, advantages and features of the invention will become apparent from the following description thereof taken in conjunction with the accompanying drawings which illustrate a specific embodiment of the invention.

FIG. 1 is a schematic diagram illustrating the structure of a printer.

FIG. 2 is a plan view showing upper surfaces of primary components of an optical scanning device provided in the printer.

FIG. 3 is a cross-sectional view along the line A-A in FIG. 2, viewed in the direction indicated by the arrows pointing the line A-A.

FIG. 4 is a schematic cross-sectional view along the line B-B in FIG. 2, viewed in the direction indicated by the arrows pointing the line B-B.

FIG. 5 is a plan view showing a bottom surface of the optical scanning device.

FIG. 6 is a side view of the optical scanning device.

FIG. 7 is a perspective view showing the structure of a light source unit provided in the optical scanning device.

FIG. 8 is another perspective view showing the structure of the light source unit.

FIG. 9 is a plan view showing the structure of the light source unit.

FIG. 10 is a diagram showing the light source unit viewed in the direction indicated by the arrow C in FIG. 9.

FIG. 11 is a cross-sectional view along the line D-D in FIG. 9, viewed in the direction indicated by the arrows pointing the line D-D.

FIG. 12 is a cross-sectional view along the line E-E in FIG. 9, viewed in the direction indicated by the arrows pointing the line E-E.

FIG. 13 is a diagram showing the light source unit viewed in the direction indicated by the arrow F in FIG. 9.

FIG. 14 is a perspective view of the light source unit viewed in the direction indicated by the arrow G in FIG. 9.

FIG. 15 is a plan view of a first holder of the light source unit.

FIG. 16 is a plan view showing an example structure of a light source unit pertaining to Modification.

FIG. 17A is a diagram showing the light source unit viewed in the direction indicated by the arrow F in FIG. 16, and FIG. 17B is a diagram showing the light source unit viewed in the direction indicated by the arrow G in FIG. 16.

### DESCRIPTION OF PREFERRED EMBODIMENT

The following describes an embodiments of an optical scanning device and an image formation apparatus that pertain to the present invention, based on an example case in which they are adopted in a tandem color digital printer (hereinafter simply referred to as “printer”).

<Overall Structure of Printer>

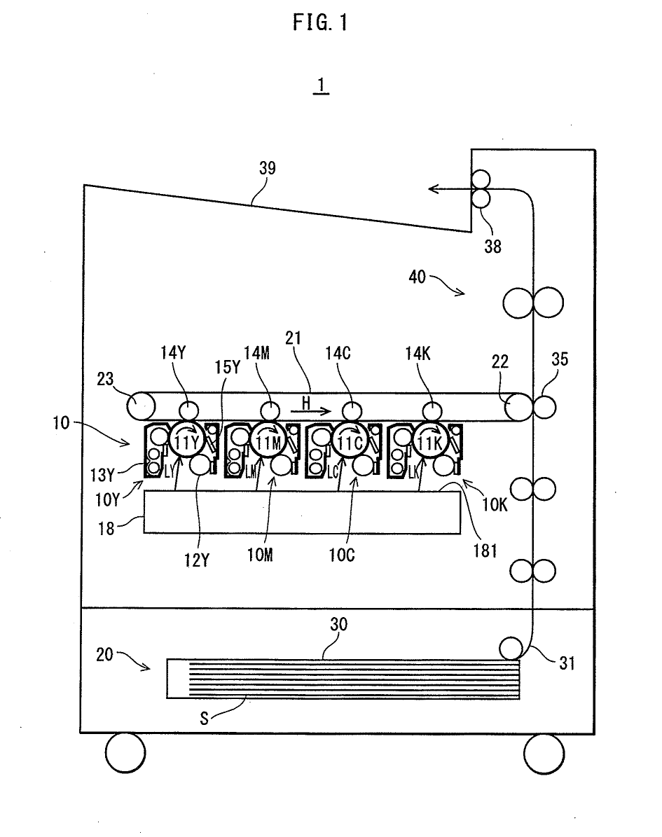

FIG. 1 is a schematic diagram illustrating the structure of a printer 1.

The printer 1 forms a full-color image on a recording sheet of such as recording paper by a well-known electrophotographic method, based on image data or the like input from an external terminal device or the like via a network (e.g. LAN).

The printer 1 includes an image formation section 10, and a paper feed section 20. The image formation section 10 forms a toner image on a recording sheet via yellow (Y), magenta (M), cyan (C), and black (K) toners. The paper feed section 20 is located below the image formation section 10.

The paper feed section 20 is provided with a paper feed cassette 30 storing recording sheets S. The recording sheets S in the paper feed cassette 30 are provided to the image formation section 10.

The image formation section 10 is provided with a pair of belt conveyor rollers 22 and 23 and an intermediate transfer belt 21. The intermediate transfer belt 21 is provided almost in the middle of the printer 1, and is wound around the belt conveyor rollers 22 and 23, so as to be positioned horizontally, and rotates around the rollers. The intermediate transfer belt 21 is rotated in the direction indicated by the arrow H by a motor not shown in the drawing. Process units 10Y, 10M, 10C and 10K are provided below the intermediate transfer belt 21.

The process units 10Y, 10M, 10C and 10K are arranged in this order, along the direction of the rotation of the intermediate transfer belt 21 (i.e. from the left to the right when viewed from the foreside (the front side) of the image formation apparatus). The process units 10Y, 10M, 10C and 10K are respectively provided with photosensitive drums 11Y, 11M, 11C and 11K each facing the intermediate transfer belt 21. A toner image of the corresponding color is formed on the circumferential surface of each of the photosensitive drums 11Y, 11M, 11C and 11K.

The photosensitive drums 11Y, 11M, 11C and 11K are arranged such that their respective axis directions are parallel with each other along the width direction (the direction perpendicular to the rotation direction) of the intermediate transfer belt 21.

An optical scanning device 18 is provided below the process units 10Y, 10M, 10C and 10K. The optical scanning device 18 emits pairs of two laser beams (hereinafter referred to as “laser beams”) LY, LM, LC and LK toward the photosensitive drums 11Y, 11M, 11C and 11K, respectively. Thus, the optical scanning device 18 scans the photosensitive drums 11Y, 11M, 11C and 11K in the horizontal scanning direction (i.e. the vertical direction of the drawing sheet), and forms electrostatic latent image on the photosensitive drums 11Y, 11M, 11C and 11K. The structure of the optical scanning device 18 is described below. Note that in the drawing and other drawings described below, each pair of two laser beams is depicted as a single straight line.

The process units 10Y, 10M, 10C and 10K are different only in the color of the toner with which a toner image is formed on the corresponding photosensitive drum, 11Y, 11M, 11C or 11K, and basically have the same function. In view of this, only the structure of the process unit 10Y is described below, and explanations of the other process units 10M, 10C and 10K are omitted.

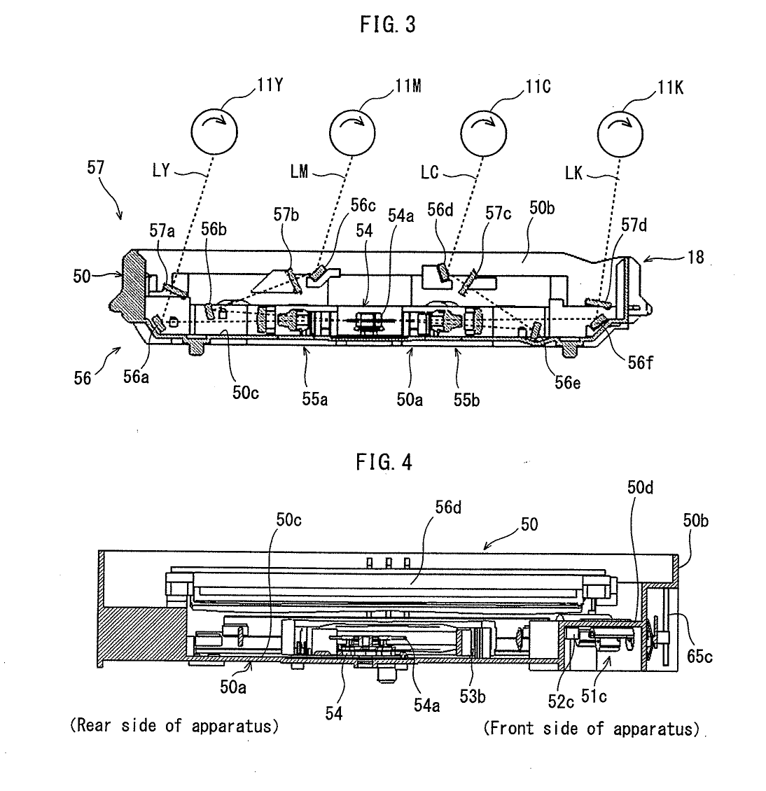

The photosensitive drum 11Y provided in the process unit 10Y is rotated in the direction indicated by the arrow shown in the drawing. The photosensitive drum 11Y is irradiated from underneath the photosensitive drum 11Y with the laser beams LY (see FIG. 3, etc.) emitted from the optical scanning device 18, and is thus exposed. A charger 12Y is provided upstream from the location on the photosensitive drum 11Y where is to be exposed by the laser beams LY, with respect to the rotation direction of the photosensitive drum 11Y. The charger 12Y faces the photosensitive drum 11Y, and uniformly charges the surface of the photosensitive drum 11Y before the surface is irradiated with the laser beams LY.

An electrostatic latent image is formed on the surface of the photosensitive drum 11Y, which has been uniformly charged by the charger 12Y, by concurrent scanning with two laser beams included in the laser beams LY. In the process unit 10Y, a developing device 13Y is provided downstream from the location on the photosensitive drum 11Y where is to be exposed by the laser beams LY, with respect to the rotation direction of the photosensitive drum 11Y. The developing device 13Y develops the electrostatic latent image formed on the surface of the photoreceptor drum 11Y, by using Y color toner.

A primary transfer roller 14Y is provided above the process unit 10Y. The primary transfer roller 14Y faces the photosensitive drum 11Y with the intermediate transfer belt 21 therebetween. The primary transfer roller 14Y is attached to the image formation section 10. A transfer bias voltage is applied to the primary transfer roller 14Y, and the primary transfer roller 14Y forms an electric field between the primary transfer roller 14Y and the photosensitive drum 11Y. Due to the effect of the electric field, the Y color toner image on the photosensitive drum 11Y is primarily transferred onto the intermediate transfer belt 21.

Primary transfer rollers 14M, 14C and 14K are respectively provided above the other process units 10M, 10C and 10K as well. The primary transfer rollers 14M, 14C and 14K respectively face the photosensitive drums 11M, 11C and 11K with the intermediate transfer belt 21 therebetween. The respective toner images formed on the photosensitive drums 11M, 11C and 11K are primarily transferred onto the intermediate transfer belt 21, due to the effect of the electric field formed between the primary transfer rollers 14M, 14C and 14K and the photosensitive drums 11M, 11C and 11K.

Regarding the operation for forming the toner images of the respective colors, the process units 10Y, 10M, 10C and 10K perform their image formation operations at different timings, so that the toner images respectively formed on the photosensitive drums 11Y, 11M, 11C and 11K are transferred onto the same area on the intermediate transfer belt 21.

Note that the surface of the photosensitive drum 11Y after the primary transfer of the toner image is cleaned by a cleaning member 15Y provided in the process unit 10Y. The same applies to the process units 10M, 10C and 10K.

A secondary transfer roller 35 is pressed against the belt conveyor roller 22 via the intermediate transfer belt 21, the belt conveyor roller 22 being downstream from the process unit 10K with respect to the rotating direction of the intermediate transfer belt 21 (the right end when viewed from the front side of the image formation apparatus) on which the toner image has been formed, and a transfer nip is formed between the intermediate transfer belt 21 and the secondary transfer roller 35. A transfer bias voltage is applied to the secondary transfer roller 35 and the secondary transfer roller 35 forms an electric field between the secondary transfer roller 35 and the intermediate transfer belt 21.

The recording sheet S, which has been taken out from the paper feed cassette 30 of the paper feed section 20 and has been transported through the transport passage 31, is supplied to the transfer nip formed between the secondary transfer roller 35 and the intermediate transfer belt 21.

The toner images of the respective colors, which have been transferred onto the intermediate transfer belt 21, are secondarily transferred onto the recording sheet S when the recording sheet S passes through the transfer nip, by the effect of the electric field formed between the secondary transfer roller 35 and the intermediate transfer belt 21.

The recording sheet S, which has passed through the transfer nip, is transported to a fixing device 40 provided above the secondary transfer roller 35. The fixing device 40 fixes the unfixed toner image on the recording sheet S by applying heat and pressure. The recording sheet S, onto which the toner image has been fixed, is ejected onto a catch tray 39 by an ejection roller 38.

<Structure of Optical Scanning Device>

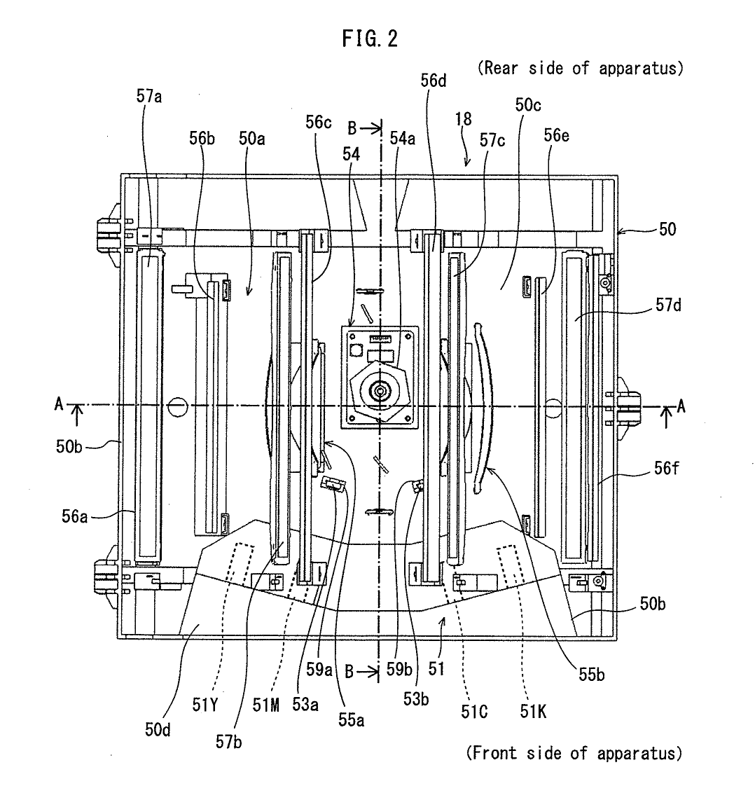

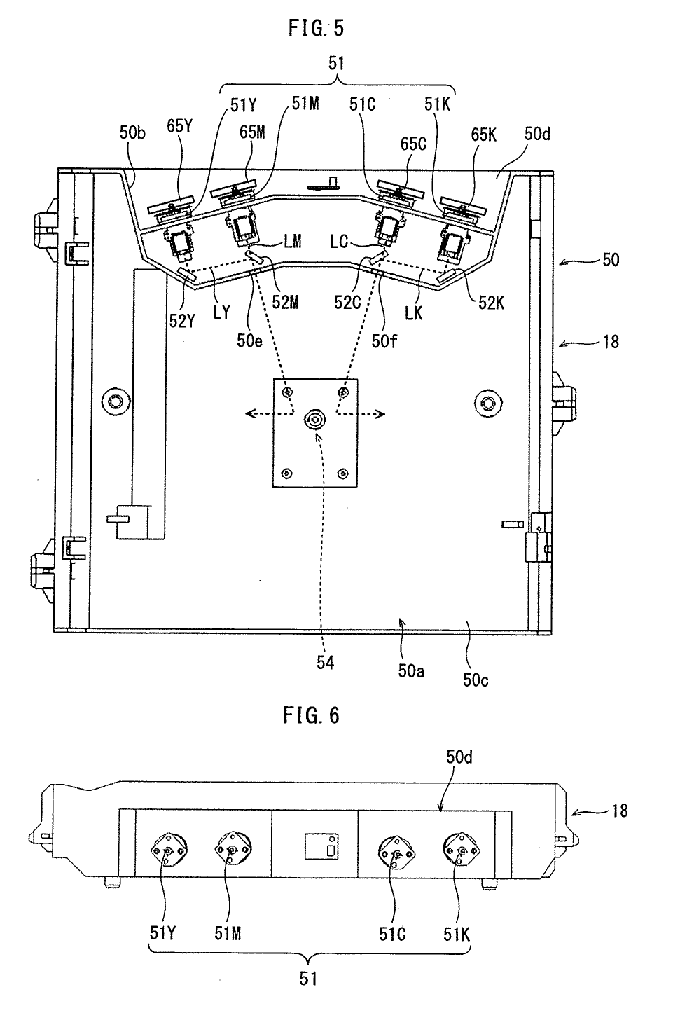

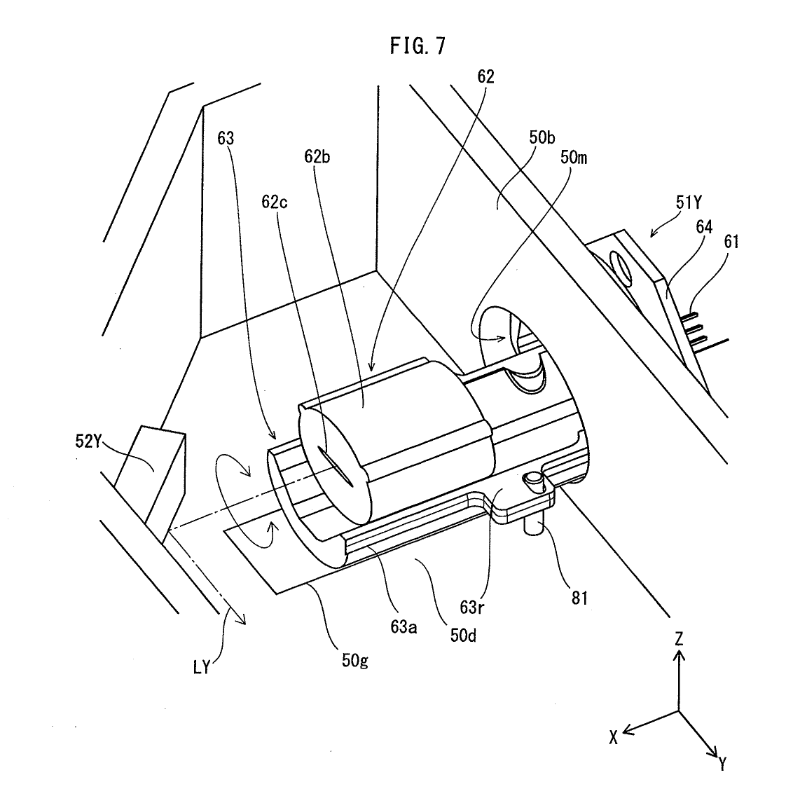

FIG. 2 is a plan view showing upper surfaces of primary components of the optical scanning device 18. FIG. 3 is a cross-sectional view along the line A-A in FIG. 2, viewed in the direction indicated by the arrows pointing the line A-A. FIG. 4 is a cross-sectional view along the line B-B in FIG. 2, viewed in the direction indicated by the arrows pointing the line B-B. FIG. 5 is a plan view showing a bottom surface of the optical scanning device, and FIG. 6 is a side view of the optical scanning device.

Note that the bottom side of FIG. 2 corresponds to the foreside (front side) of the image formation apparatus (printer 1), and the top side of FIG. 2 corresponds to the backside (rear side) of the image formation apparatus. In FIG. 4, the right side corresponds to the front side, and the left side corresponds to the rear side. The line B-B in FIG. 2 is parallel with the horizontal scanning direction, and corresponds to the straight line perpendicular to the rotation shaft of the polygon mirror 54a. FIG. 3 also shows the positional relationship between the optical scanning device 18 and the photosensitive drums 11Y, 11M, 11C and 11K in the process units 10Y, 10M, 10C and 10K provided above the optical scanning device 18. In FIG. 6, a driver substrate, which is described below, is omitted.

As shown in FIG. 2 through FIG. 6, the optical scanning device 18 includes a device housing 50, and a light source 51, reflective mirrors 52Y and 52K, beam synthesizers 52M and 52C, cylindrical lenses 53a and 53b, a deflector 54, scanning lenses 55a and 55b, turn-back mirrors 56, and second fθ lenses 57 (57a-57d) are housed in the device housing 50.

The device housing 50 is a resin or metal member that includes a base 50a and a side wall (external wall) 50b. The base 50a is flat, and roughly has a rectangular shape in plan view. The side wall 50b stands from the sides of the base 50a in the vertical direction. The device housing 50 has an open top.

The open top makes it easy to, in the manufacturing process, put optical elements, such as the deflector 54 and the scanning lens 55a, into the device housing 50 from the opening, toward the base 50a, and to arrange the elements at predetermined positions on the base 50a.

If the device housing 50 is left open, dirt or dust might enter into the device housing 50, and might adhere to the optical elements. This raises possibilities that the dirt or the like distorts the light path and deteriorates the image quality. To prevent intrusion of dust or the like, a thin lid 181 (see FIG. 1) is attached to the side wall 50b so as to cover the opening.

In the lid 181, a portion corresponding to the light path of the laser beams, which are described later, has holes (omitted from the drawings) for passing the laser beams. Transparent glasses (omitted from the drawings) are fit into the holes.

The base 50a is fixed to and supported by a device body frame (omitted from the drawings), and includes a first bottom part 50c and a second bottom part 50d as shown in FIG. 4. The second bottom part 50d is contiguous with the first bottom part 50c and is located at a higher level than the first bottom part 50c.

The cylindrical lens 53a and 53b (FIG. 2), the deflector 54, the scanning lenses 55a and 55b, for example, are arranged on the upper surface of the first bottom part 50c. The light source 51 (FIG. 5), the reflective mirrors 52Y and 52K, and the beam synthesizers 52M and 52C, for example, are arranged on the bottom surface of the second bottom part 50d.

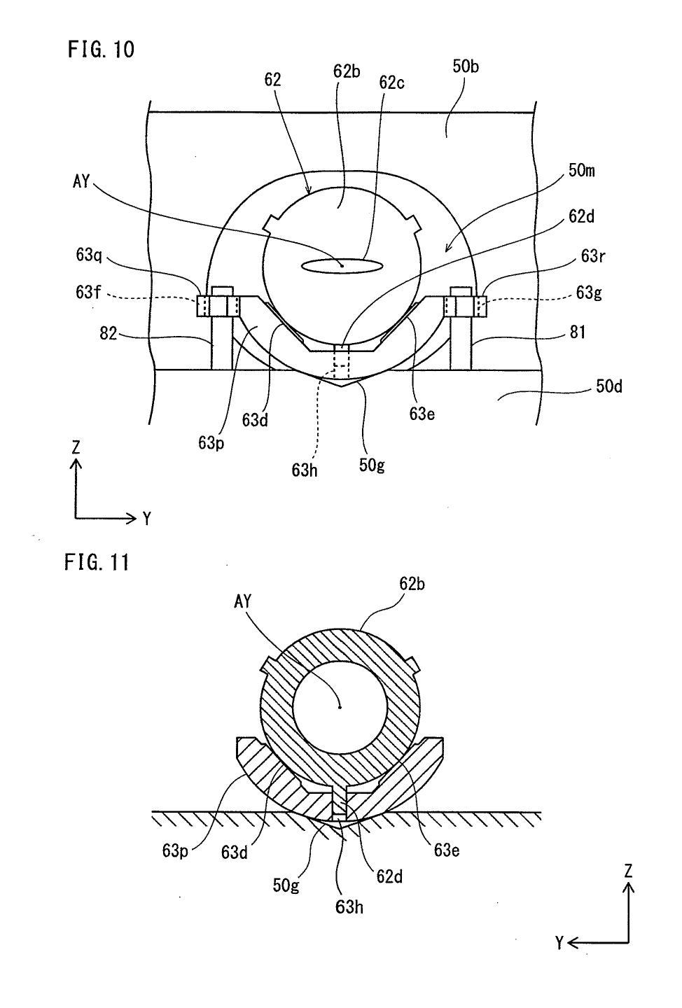

The light source 51 includes light source units 51Y, 51M, 51C and 51K respectively emitting laser beams LY, LM, LC and LK for scanning the photosensitive drums 11Y, 11M, 11C and 11K. Driver boards 65Y, 65M, 65C and 65K for supplying drive power to the light source units 51Y, 51M, 51C and 51K and controlling the light emission timings and the light amounts are provided near the light source units 51Y, 51M, 51C and 51K. The structures of the light source units 51Y-51K are described later. Note that the second bottom part 50d is configured to change the locations, in terms of the levels, of the light source units 51Y, 51M, 51C and 51K from each other. To change the levels of the light source units 51Y, 51M, 51C and 51K from each other, the second bottom part 50d may be provided with stepped portions, or V grooves 50g (FIG. 10), which are described later, may have different depths.

The reflective mirror 52Y reflects the laser beams LY emitted from the light source unit 51Y, and guides the laser beams LY to the beam synthesizer 52M.

The beam synthesizer 52M is, for example, a beam splitter composed of two polished prisms bonded together. The beam synthesizer 52M deflects the laser beams LY, which have been reflected by the reflective mirror 52Y, by 90°, and at the same time, lets the laser beams LM emitted from the light source unit 51M pass through the beam synthesizer 52M. Thus, the beam synthesizer 52M aligns the traveling directions of the laser beams LY and the laser beams LM.

The laser beams LY, which have been deflected by the beam synthesizer 52M, and the laser beams LM, which have passed through the beam synthesizer 52M, pass through a through-hole 50e (FIG. 5) provided in a step of the base 50a, and is then guided to the cylindrical lens 53a (FIG. 2).

The cylindrical lens 53a is a lens for condensing the laser beams LY and the laser beams LM in the vertical scanning direction, and guiding the beams to the deflector 54. The cylindrical lens 53a is supported on the base 50a via a supporting member 59a.

The reflective mirror 52K (FIG. 5) reflects the laser beams LK emitted from the light source unit 51K, and guides the laser beams LK to the beam synthesizer 52C.

The beam synthesizer 52C has the same structure as the beam synthesizer 52M. The beam synthesizer 52C deflects the laser beams LK, which have been reflected by the reflective mirror 52K, by 90°, and at the same time, lets the laser beams LC emitted from the light source unit 51C pass through the beam synthesizer 52C. Thus, the beam synthesizer 52C aligns the traveling directions of the laser beams LC and the laser beams LK.

The laser beams LK, which have been deflected by the beam synthesizer 52C, and the laser beams LC, which have passed through the beam synthesizer 52C, pass through a through-hole 50f (FIG. 5) provided in a step of the base 50a, and is then guided to the cylindrical lens 53b (FIG. 2).

The cylindrical lens 53b is a lens for condensing the laser beams LC and the laser beams LK in the vertical scanning direction, and guiding the beams to the deflector 54. The cylindrical lens 53b is supported on the base 50a via a supporting member 59b.

The deflector 54 rotates, with a motor, the polygon mirror 54a having six reflective surfaces about the rotation shaft of the polygon mirror 54a, at a constant rotation speed. Thus, the deflector 54 deflects the incident laser beams LY-LK.

In Embodiment, a first incident position, which is the incident position of the laser beams LY and LM, and a second incident position, which is the incident position of the laser beams LC and LK, are opposite each other with respect to the imaginary plane that includes the rotation shaft of the polygon mirror 54a and the line B-B (the line parallel to the horizontal scanning direction).

The laser beams LY and LM, which have been deflected at the first incident position, are guided by the scanning lens 55a. The laser beams LC and LK, which have been deflected at the second incident position, are guided by the scanning lens 55b.

The scanning lenses 55a and 55b are opposite each other with the polygon mirror 54a therebetween. The scanning lenses 55a and 55b are each composed of first fθ lenses, and guide the laser beams LY-LK to the photosensitive drums 11Y-11K via the turn-back mirrors 56 and the second fθ lenses 57.

Specifically, the laser beams LY (FIG. 3) pass through the scanning lens 55a, are reflected by a turn-back mirror 56a, are condensed in the vertical scanning direction when passing through a second fθ lens 57a, and then form an image on the photosensitive drum 11Y.

The laser beams LM pass through the scanning lens 55a, are reflected by a turn-back mirror 56b, are condensed in the vertical scanning direction when passing through a second fθ lens 57b, are reflected by a turn-back mirror 56c, and then form an image on the photosensitive drum 11M.

The laser beams LC pass through the scanning lens 55b, are reflected by a turn-back mirror 56e, are condensed in the vertical scanning direction when passing through a second fθ lens 57c, are reflected by a turn-back mirror 56d, and then form an image on the photosensitive drum 11C.

The laser beams LK pass through the scanning lens 55b, are reflected by a turn-back mirror 56f, are condensed in the vertical scanning direction when passing through a second fθ lens 57d, and then form an image on the photosensitive drum 11K.

<Structure of Light Source Unit>

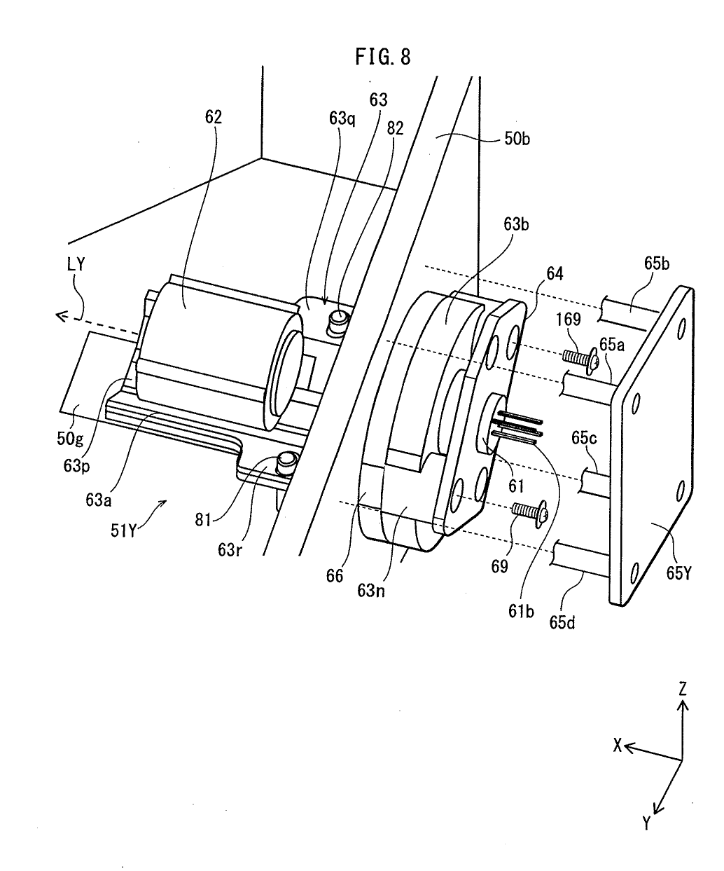

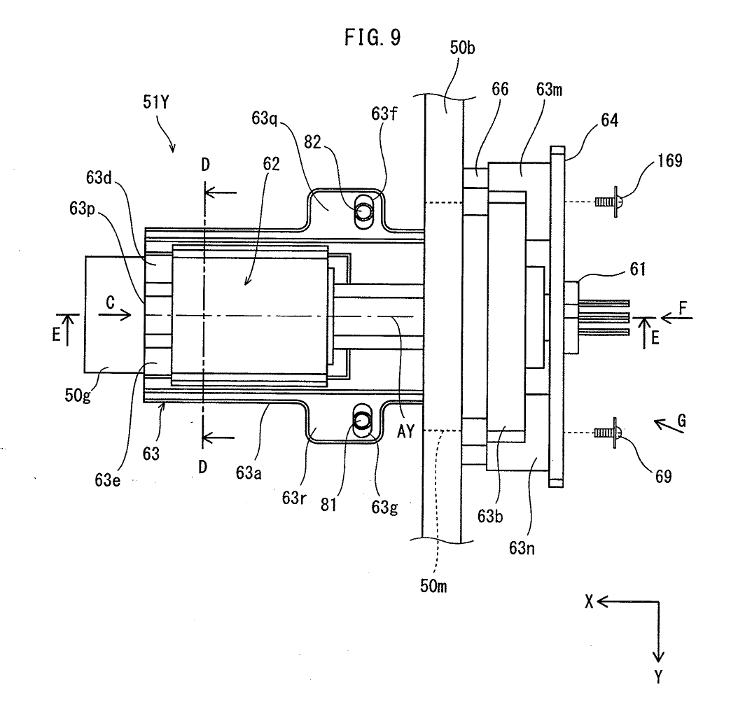

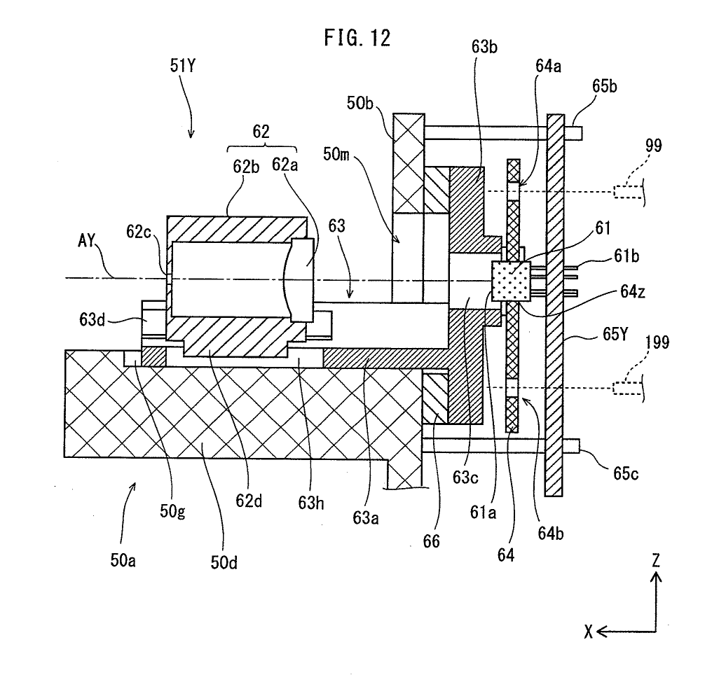

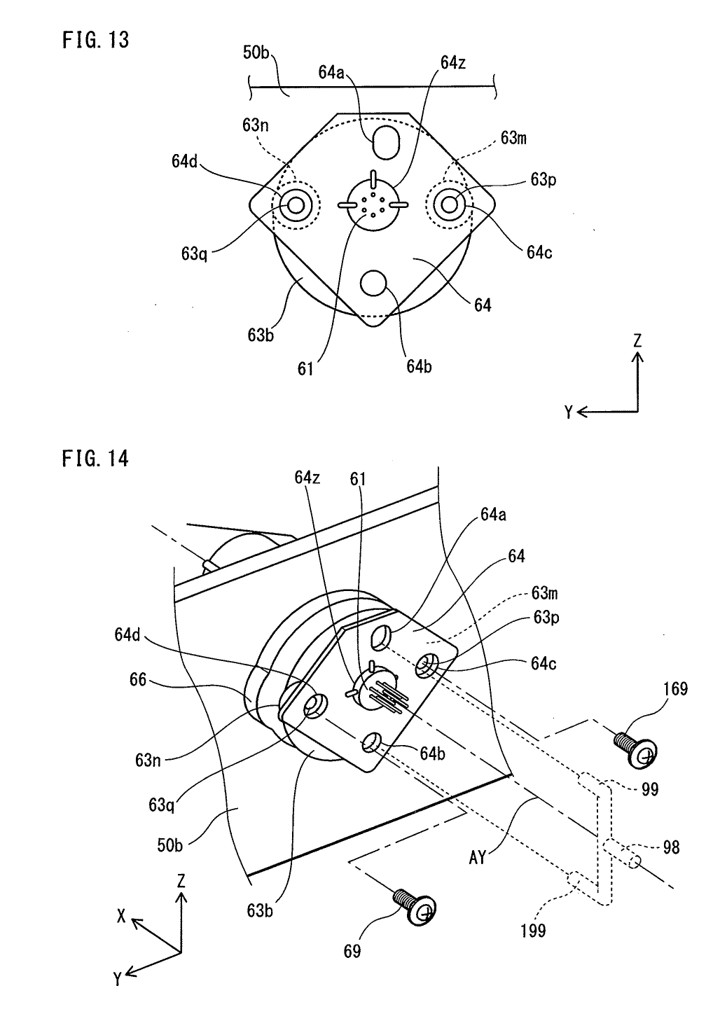

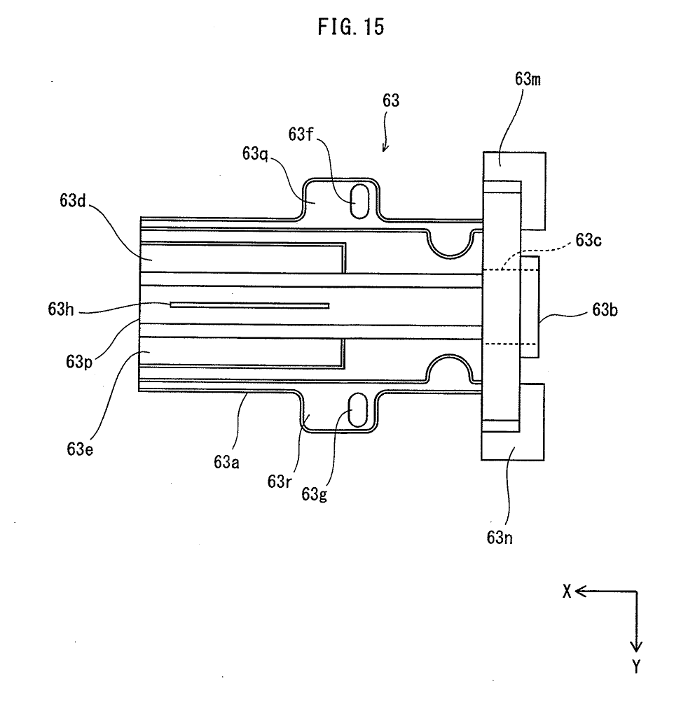

FIG. 7 and FIG. 8 are perspective views showing the structure of the light source unit 51Y. FIG. 9 is a plan view showing the structure of the light source unit 51Y. FIG. 10 is a diagram showing the light source unit 51Y viewed in the direction indicated by the arrow C in FIG. 9. FIG. 11 is a cross-sectional view along the line D-D in FIG. 9, viewed in the direction indicated by the arrows pointing the line D-D. FIG. 12 is a cross-sectional view along the line E-E in FIG. 9, viewed in the direction indicated by the arrows pointing the line E-E. FIG. 13 is a diagram showing the light source unit 51Y viewed in the direction indicated by the arrow F in FIG. 9. FIG. 14 is a perspective view of the light source unit 51Y viewed in the direction indicated by the arrow G in FIG. 9. FIG. 15 is a plan view of a first holder 63 of the light source unit 51Y.

As described above, the light source unit 51Y is attached to the bottom surface of the second bottom part 50d of the base 50a. However, in FIG. 7 and later, the light source unit 51Y is upside-down and is viewed from above.

The X, Y and Z axes, which are perpendicular to each other, are denoted as arrows, and the direction indicated by the arrow X corresponds to the traveling direction of the laser beams. In the following, for specifying the traveling direction of the laser beams, the direction indicated by the arrow X may be referred to as “the beam traveling direction”.

As shown in FIG. 7 through FIG. 14, the light source unit 51Y includes a semiconductor laser 61, a collimator lens part 62, a first holder 63, and a second holder 64.

The first holder 63 is a resin member, for example, and includes a horizontal part 63a (first part), a vertical part 63b (second part) (FIG. 15). The longitudinal direction of the horizontal part 63a corresponds to the X axis direction. The vertical part 63b extends, along the Z axis, opposite to the direction of the second bottom part 50d, from the upstream end of the horizontal part 63a with respect to the beam traveling direction.

The horizontal part 63a includes a main body 63p and protruding parts 63q and 63r. The main body 63p has an arc-shaped cross-section in a plane perpendicular to the X axis. The protruding parts 63q and 63r extend outward along the Y axis direction, from the ends of the main body 63p in the circumferential direction. In terms of the X axis direction, the protruding parts 63q and 63r extend from roughly the middle points on the main body 63p in the X axis direction.

The collimator lens part 62 is held on the inner surface of the main body 63p, and the outer circumferential surface (facing the base 50a) of the main body 63p is held on the second bottom part 50d of the device housing 50. The outer circumferential surface of the main body 63p has an arc-shaped cross-section in a plane perpendicular to the X axis.

In the second bottom part 50d, a groove 50g (FIG. 10) having a V-shaped cross-section in a plane perpendicular to the X axis is provided along the X axis. The main body 63p of the first holder 63 is fit into the V-shaped groove 50g such that the outer circumferential surface of the main body 63p of the first holder 63, which has a cross-section in the shape of an arc, is supported at two points (two-point support) with an interval therebetween in the circumferential direction.

The protruding parts 63q and 63r are respectively provided with slots 63f and 63g each having a long opening extending in the Y direction. Pins 81 and 82, which protrude from the second bottom part 50d in the Z direction, are fit into the slots 63f and 63g. The slots 63f and 63g in the Y direction are longer than the diameter of the pins 81 and 82, and the width of the slots 63f and 63g is slightly larger than the diameter of the pins 81 and 82.

The pins 81 and 82 provided on the second bottom part 50d are respectively fit into the slots 63f and 63g provided in the first holder 63. Thus, the first holder 63 is restricted from moving in the X direction, and to be freely rotatable in the direction indicated by the arrow shown in FIG. 7 (the direction around the optical axis AY of the collimator lens 62a described below: “around the optical axis”), within the range of the looseness determined by the relation between the diameters of the pins 81 and 82 and the lengths of the slots 63f and 63g. As described above, the first holder 63 is supported on the second bottom part 50d so as to be rotatable around the optical axis. This is in order to make it possible to adjust the beam pitch on the photosensitive drum 11Y of the two laser beams constituting the laser beams LY emitted from the semiconductor laser 61 (beam pitch adjustment). The beam pitch adjustment is described below.

In the bottom of the main body 63p, a slot 63h (FIG. 15) is provided along the X direction. Also, on the inner surface of the main body 63p, lens holder parts 63d and 63e (first holder part) for holding the collimator lens part 62 are provided at both ends in the circumferential direction, with the slot 63h therebetween.

The collimator lens part 62 includes a collimator lens 62a (FIG. 12) and a lens barrel 62b for holding the collimator lens 62a.

The collimator lens 62a collimates the two laser beams (diffusion beams) emitted from the semiconductor laser 61. The collimator lens 62a is held by the lens barrel 62b such that the optical axis AY is parallel to the X axis.

The lens barrel 62b extends in the X axis direction, and has a cylindrical shape. The collimator lens 62a is held at the upstream end of the lens barrel 62b with respect to the traveling direction of the laser beams. The downstream end of the lens barrel 62b with respect to the traveling direction of the laser beams is closed with a lid that is provided with a slot 62c extending in the Y direction.

The bottom of the lens barrel 62b is provided with a linear protrusion 62d formed along the X axis direction. The linear protrusion 62d fits into a slot 63h formed in the bottom of the main body 63p of the first holder 63. The length of the linear protrusion 62d in the X axis direction is shorter than the length of the slot 63h in the X axis direction. Thus, under the condition that the linear protrusion 62d of the lens barrel 62b has been fit in the slot 63h of the first holder 63, the lens barrel 62b is supported so as to be freely movable in the X axis direction with respect to the first holder 63, within the range of the difference between the lengths.

As described above, the lens barrel 62b is freely movable in the X axis direction with respect to the first holder 63. This is in order to make it possible to adjust the focus of the collimator lens 62a in the optical axis direction (focus adjustment). The focus adjustment is described below.

Note that the width (the thickness in the Y axis direction) of the linear protrusion 62d is slightly shorter than the width of the slot 63h. The widths of the linear protrusion 62d and the slot 63h are determined such that they do not slip in the Y axis direction. The slot 63h is a through-hole, which penetrates through the main body 63p. The height (the length in the Z axis direction) of the linear protrusion 62d and the depth of the slot 63h are determined such that the protrusion end of the linear protrusion 62d does not protrude from the main body 63p when the linear protrusion 62d fits into the slot 63h.

The lens barrel 62b contacts with the main body 63p only on areas facing the lens holding parts 63d and 63e on the outer circumferential surface of the lens barrel 62b, and is thus held by the main body 63p. Note that although the linear protrusion 62d contacts with the main body 63p via the slot 63h of the main body 63p, the linear protrusion 62d almost freely moves in the Z axis direction, and it can not be said that the linear protrusion 62d is held by the main body 63p.

The lens holding parts 63d and 63e serve as reference surfaces for positioning the optical axis AY of the collimator lens 62a. The size, the shape and so on of the lens holding parts 63d and 63e are determined such that under the condition where the lens holding parts 63d and 63e are in contact with the outer circumferential surface of the lens barrel 62b, the optical axis AY of the collimator lens 62a is located in a predetermined position in terms of the Z axis direction, with respect to the first holder 63.

In the Embodiment, as shown in FIG. 10 and FIG. 11, the lens holding parts 63d and 63e are symmetrically located with respect to an imaginary plane that includes the optical axis AY of the collimator lens 62a and the Z axis. Each of the lens holding parts 63d and 63e is inclined at a predetermined angle to the imaginary plane. Thus, the cross-section of the lens holding parts 63d and 63e cut along a plane perpendicular to the optical axis AY has a groove-like V-shape.

The horizontal part 63a of the first holder 63 penetrates through, in the optical axis direction, a through-hole 50m provided in the side wall 50b of the device housing 50, without contacting the side wall 50b, and thus lies in the horizontal direction. The horizontal part 63a has lens holding parts 63d and 63e and protruding parts 63q and 63r provided in the downstream end thereof (inside the device housing 50), which is downstream from the side wall 50b with respect to the traveling direction of the laser beams. The horizontal part 63a also has vertical part 63b provided in the upstream end thereof (outside the device housing 50), which is upstream from the side wall 50b with respect to the traveling direction of the laser beams.

The vertical part 63b has a plate-like shape, and a through-hole 63c is provided in the center thereof. The semiconductor laser 61 is fit into the through-hole 63c. The two laser beams emitted from the semiconductor laser 61 pass through the through-hole 63c of the vertical part 63b and the through-hole 50m of the side wall 50b of the device housing 50, and enter the collimator lens 62a.

The semiconductor laser 61 is a light-emitting element having a plurality of light emission points, specifically two points in this Embodiment, and each of the two light emission points provided with an interval therebetween on a surface 61a (FIG. 12) that is closer to the light emission part, emits a laser beam. These two laser beams constitute the laser beams LY.

The semiconductor laser 61 is held by the second holder 64 (second holder part) having a plate-like shape. The second holder 64 is supported on the vertical part 63b of the first holder 63. The second holder 64 and the vertical part 63b exist outside the device housing 50 with respect to the side wall 50b. Thus, in the manufacturing, it is easy to perform processes of, for example, attaching the second holder 64, which holds the semiconductor laser 61, to the vertical part 63b of the first holder 63 from the outside.

As shown in FIG. 13 and FIG. 14, the second holder 64, which has a rectangular shape in side view, has a through-hole 64z provided in the center thereof, a pair of through-holes 64a and 64b provided with an interval in the Z axis direction so as to sandwich the through-hole 64z, and a pair of through-holes 64c and 64d provided with an interval in the Y axis direction so as to sandwich the through-hole 64z.

The semiconductor laser 61 is fit into the through-hole 64z provided in the center of the second holder 64 such that the surface 61a that is closer to the light emission part faces the collimator lens 62a.

The two through-holes 64c and 64d arranged along the Y axis direction are holes that screws 169 and 69 pass through. The screws 169 and 69 fix the second holder 64 to the vertical part 63b of the first holder 63. The screws 169 and 69 are respectively screwed into screw holes 63p and 63q in seatings 63m and 63n provided on the vertical part 63b via the through-holes 64c and 64d, and thus the second holder 64 are fixed to and supported on the vertical part 63b of the first holder 63.

Before fixing the second holder 64, positioning of the semiconductor laser 61 with respect to the collimator lens 62a (i.e. positioning in the Y-Z plane) is performed. This positioning is called alignment process. The details of the alignment process are described below.

As shown in FIG. 12, a sealing member 66 is inserted between the vertical part 63b of the first holder 63 and the side wall 50b of the device housing 50. The sealing member 66 is for filling the gap between the vertical part 63b and the side wall 50b. The sealing member 66 prevents dirt and dust outside the device housing 50 from entering inside the device housing 50 via the through-hole 50m of the side wall 50b.

In this Embodiment, the sealing member 66 is made of an elastic material such as sponge. The sealing member 66 is formed in a ring-like shape on the outer surface of the side wall 50b so as to surround the through-hole 50m, and is sandwiched between the side wall 50b and the vertical part 63b so as to be closely attached to their surfaces. Thus, the sealing member 66 prevents dirt and the likes from entering inside the device housing.

The semiconductor laser 61 and the collimator lens 62a are held by the first holder 63. The first holder 63 is supported on the second bottom part 50d of the device housing 50.

As described above, the semiconductor laser 61 is supported on the second bottom part 50d of the device housing 50 via the first holder 63. This is for preventing, as much as possible, the light paths of the laser beams from being changed in position as the environment around the device (e.g. temperature and humidity) changes.

Specifically, the device housing 50 includes the base 50a and the side wall 50b and has an open top, and the second bottom part 50d as a part of the base 50a is contiguous with the side wall 50b and does not have a free end, whereas the top end of the side wall 50b, which is opposite to the base 50a, is a free end. The second bottom part 50d (the base 50a) is fixed to and supported by the device body frame.

When stress which can be a cause of overall distortion of the device housing 50, for example, occurs due to, for example, thermal expansion caused by changes in the environment around the device (temperature and humidity), the light paths are hardly changed in position since the second bottom part 50d has a higher rigidity than the side wall 50b which is closer to the free end. For the same reason, the deflector 54, which has the polygon mirror 54a which is rotated at a high speed, is also supported on the base 50a.

As described above, the semiconductor laser 61, as with the deflector 54, is supported on the base 50a. Thus, positional changes of the light paths of the laser beams due to the environmental changes are reduced as much as possible. The light paths of the two laser beams are not readily displaced from their original locations, and the beam pitch on the photosensitive drum 11Y does not change easily. This moderates the deterioration of the quality caused by the fluctuations in beam pitch.

Note that although the base 50a has a step between the first bottom part 50c, which supports the deflector 54, and the second bottom part 50d, which supports the light source unit 51Y, this step does not reduce the mechanical strength. This is because the first bottom part 50c and the second bottom part 50d are both included in the base 50a, and the step is contiguous with the first bottom part 50c and the second bottom part 50d and does not form a free end. Hence, the step can be considered as being integrated with the first bottom part 50c and the second bottom part 50d. Therefore, the fact remains that the base 50a is not susceptible to environmental changes, in comparison with the side wall 50b having a free end. Furthermore, although the vertical part 63b of the first holder 63 is in contact with the side wall 50b via the sealing member 66, the sealing member 66 is made of an elastic material such as sponge, and absorbs the positional changes of the side wall 50b. Thus, the first holder 63 is not affected by the positional changes.

A plurality of lead wires 61b for receiving power and control signals are extended from the opposite surface of the semiconductor laser 61 to the surface 61a that is closer to the light emission part. The tips of the lead wires 61b are soldered to the driver board 65Y.

The driver board 65Y is a printed board. In this Embodiment, the driver board 65Y has a rectangular shape in plan view, as shown in FIG. 8, FIG. 12, and so on. Note that the driver board 65Y is omitted from some of the drawings in order to clarify the positional relationship between the first holder 63 and the semiconductor laser 61.

The driver board 65Y is supported by four supporting members each having a rod-like shape, namely supporting members 65a-65d, and is fixed to the device housing 50. In the Embodiment, one ends of the supporting members 65c and 65d are fixed to the second bottom part 50d of the device housing 50, and the other ends are fixed to two corners of the driver board 65Y that are closer to the second bottom part 50d. One ends of the supporting members 65a and 65b are fixed to the side wall 50b of the device housing 50, and the other ends are fixed to two corners of the driver board 65Y that are farther from the second bottom part 50d.

Since the driver board 65Y is supported on the device housing 50 via the two supporting members 65c and 65d fixed to the second bottom part 50d, the mechanical strength is higher than a structure in which all the four supporting members are supported on the side wall 50b. The driver board 65Y is located outside the side wall 50b of the device housing 50. Hence, even when the driver board 65Y is subject to external force, for example when hit by hand during the manufacturing or maintenance process, the external force is transmitted to and received by the second bottom part 50d which has a high mechanical strength, via the supporting members 65a and 65d. Thus, the force is not directly transmitted to the light source unit 51Y.

Thus, the light source unit 51Y is prevented from being physically displaced due to impact on the light source unit 51Y caused by external force. This prevents deterioration of the image quality due to fluctuation in beam pitch caused by the displacement. In view of the above, it is preferable that at least one of the supporting members 65 is fixed to the base 50a.

Note that in the manufacturing of the Embodiment, the driver board 65Y is attached to the device housing 50 after all the processes from the alignment process to the beam pitch adjustment have been completed.

The following sequentially explains the methods for the alignment process, the focus adjustment and the beam pitch adjustment.

<Alignment Process>

(1) Under the condition that the second holder 64 (FIG. 14) is loosely attached to the vertical part 63b of the first holder 63 with the screws 69 and 169, the ends of two rod members 99 and 199 of an alignment jig 98 (depicted in dashed line in FIG. 14) are inserted into the through-holes 64a and 64b of the second holder 64. The jig 98 is movable on the plane perpendicular to the optical axis AY, that is, on the Y-Z plane. The focus adjustment for the collimator lens 62a is performed in the next step. The alignment process is performed under the condition where the focus is roughly adjusted, and fine adjustment of the focus is performed in the next step.

(2) The semiconductor laser 61 is caused to emit a laser beam from one of the light emission points in order to form a beam spot on the detection surface (irradiated surface) of the photoelectric sensor such as CCD disposed in the same optical position as the photosensitive drum 11Y. Note that at the stage of the alignment process, the driver board 65Y (described later) for providing driving power to the semiconductor laser 61 has not been installed. Hence, a power supply connector (not depicted) is connected to the plurality of lead wires 61b, which are used for receiving power and are extended from the surface of the semiconductor laser 61 that is opposite to the surface 61a closer to the light-emitting part, and thus the semiconductor laser 61 is provided with power.

(3) The position of the semiconductor laser 61 on the Y-Z plane is adjusted by moving the jig 98 so that the center point of the beam spot comes to the center point of a cross image printed in advance on the detection surface. At this stage, the center point (i.e. the peak in the intensity distribution) of the beam spot of the laser beam incident to the detection surface is detected from the intensity distribution, and thus the relative position of the center point of the beam spot with reference to the center point of the cross image on the detection surface is detected.

Note that the positional relationship between the collimator lens 62a and the detection surface is determined in advance such that the center point of the cross image on the detection surface indicates the position of the optical axis of the collimator lens 62a. Here, the alignment process is performed to adjust semiconductor laser 61 such that the center point of the beam spot of the laser beam from one of the light emission points coincides with the optical axis of the collimator lens 62a. However, the alignment process may be performed such that the middle point between one of the light emission points and the other one of the light emission points coincides with the optical axis of the collimator lens 62a. If this is the case, the laser beams are alternately emitted from each light emission point, and the position on the semiconductor laser 61 on the Y-Z plane is adjusted by moving the jig 98 such that the distance between the center point of the beam spot of the laser beam emitted from one of the light emission points and the center point of the cross image on the detection surface equals to the distance between the center point of the beam spot of the laser beam emitted from the other one of the light emission points and the center point of the cross image on the detection surface.

(4) When it is detected that the center point of the beam spot coincides with the center point of the cross image, the jig 98 is stopped, and the screws 69 and 169, which have been loosely attached, is now tightened. Thus, the positioning (alignment) of the semiconductor laser 61 with reference to the collimator lens 62a is completed.

<Focus Adjustment>

The focus adjustment is performed after the alignment process, according to the following steps.

(1) The semiconductor laser 61 is caused to emit a laser beam from one of the light emission points in order to form a beam spot on the detection surface of the photoelectric sensor as described above.

(2) Whether or not the formed beam spot is in focus is determined based on the beam diameter calculated from the beam intensity distribution detected by the photoelectric sensor.

(3) When it is detected that the beam spot is not in focus, the lens barrel 62b is moved bit by bit in the direction of the optical axis AY with reference to the horizontal part 63a of the first holder 63 until it is detected that the beam spot is in focus.

(4) When it is detected that the beam spot is in focus, the movement of the lens barrel 62b is stopped, and the lens barrel 62b is fixed to the horizontal part 63a of the first holder 63. In this Embodiment, an adhesive agent is filled into the contact areas between the outer circumferential surfaces of the lens barrel 62b and the lens holding parts 63d and 63e of the horizontal part 63a of the first holder 63, and thus the lens barrel 62b is fixed.

<Beam Pitch Adjustment>

The beam pitch adjustment is performed after the focus adjustment, according to the following steps.

(1) The semiconductor laser 61 is caused to emit two laser beams simultaneously, in order to form a beam spot on the detection surface of the photoelectric sensor as described above.

(2) On the detection surface, the beam pitch (interval) between the formed two beam spots in the vertical scanning direction is obtained from the beam intensity distribution of the two beam spots.

(3) When it is detected that the beam pitch is not the predetermined value, the horizontal part 63a of the first holder 63 is rotated about the optical axis bit by bit, with reference to the second bottom part 50d of the device housing 50 until it is detected that the beam pitch is the predetermined value.

(4) When it is detected that the beam pitch is the predetermined value, the rotation of the first holder 63 is stopped, and the horizontal part 63a of the first holder 63 is fixed to the second bottom part 50d of the device housing 50. In this Embodiment, an adhesive agent is filled into the contact area between the bottom surface of the horizontal part 63a of the first holder 63 and the groove 50g in the second bottom part 50d of the device housing 50, and thus the first holder 63 is fixed.

Note that the degree of the looseness of the pins 81 and 82 provided on the second bottom part 50d, with respect to the slots 63f and 63g provided in the first holder 63, is determined in advance so that the amount of the rotation of the first holder 63 about the optical axis, with reference to the second bottom part 50d of the device housing 50, is sufficient for the beam pitch adjustment.

As described above, the alignment process, in which the position of the semiconductor laser 61 with respect to the collimator lens 62a is adjusted along the Y-Z plane (the plane perpendicular to the X axis) and the beam pitch adjustment, in which the semiconductor laser 61 is rotated about the optical axis (X axis), can be performed separately. Thus, the adjustment is easier than, for example, three-axis adjustment in which the semiconductor laser 61 is moved along the Y-Z plane while being rotated about the X axis which is perpendicular to the Y-Z plane at the same time.

Also, since the semiconductor laser 61 is supported on the device housing 50 via the first holder 63, and the cylindrical lens 53a is supported by the device housing 50 via the supporting member 59a other than the first holder 63, the cylindrical lens 53a is not rotated together with the first holder 63 when the first holder 63 is rotated about the optical axis in the beam pitch adjustment.

For example, if the cylindrical lens is also supported by the first holder 63, the cylindrical lens is rotated in the same direction for the same amount as the first holder 63 when the first holder 63 is rotated about the optical axis. If the cylindrical lens is rotated, the angle of inclination of the laser beams condensed by the cylindrical lens so as to form a straight line, with respect to the rotation shaft of the polygon mirror 54a, is deviated from the proper angle. Such deviation of the inclination angle from the proper angle distorts the scanning beam on the photosensitive drum 11Y after the deflection, which leads to deterioration of the image quality. Thus, in beam pitch adjustment, it is necessary to perform positioning of the cylindrical lens 53a in the rotation direction at the same time as the adjustment of the beam pitch. This sometimes takes a long time.

In contrast, when the first holder 63 and the cylindrical lens 53a are supported by different supporting members as with the Embodiment, the beam pitch and the distortion of the laser beams are separately adjustable, which makes the adjustment easy.

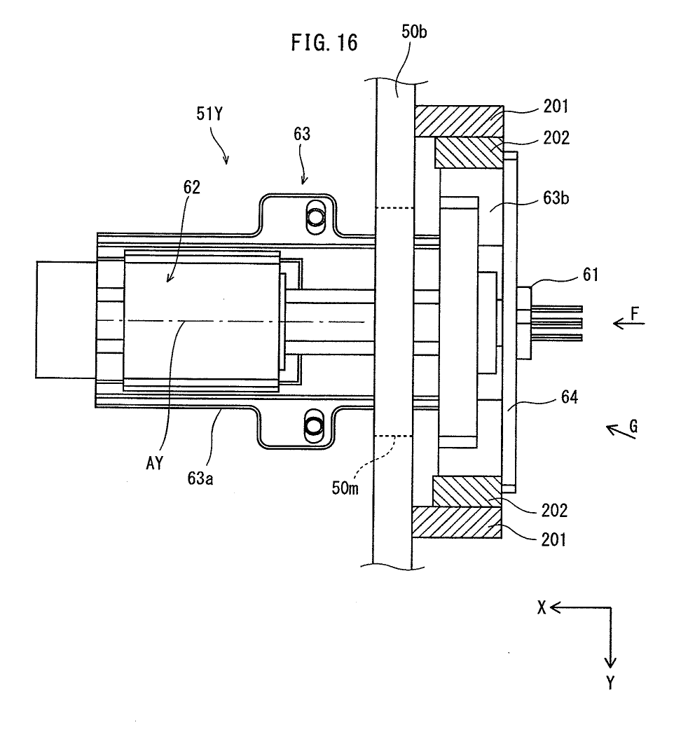

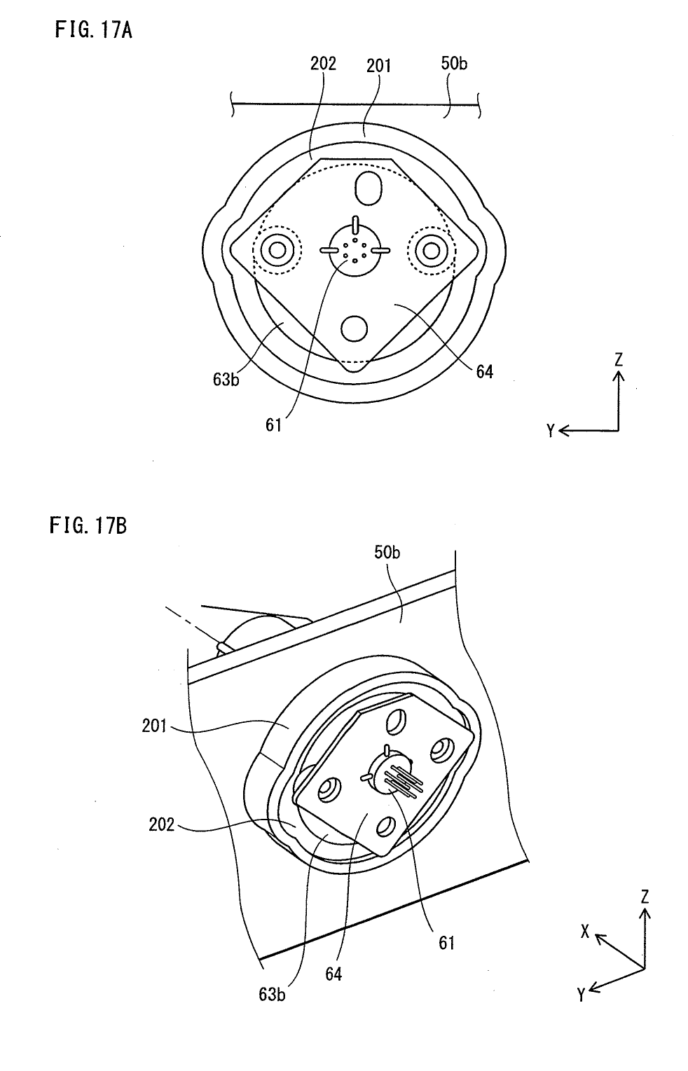

In the description above, the gap between the vertical part 63b of the first holder 63 and the side wall 50b is filled with the sealing member 66 in order to prevent dirt or the likes from entering inside the device housing 50. However, such a structure is not essential. For example, the structures shown in FIG. 16 and FIG. 17 may be adopted.

FIG. 16 is a plan view showing an example structure of a light source unit 51Y pertaining to Modification. FIG. 17A is a diagram showing the light source unit 51Y viewed in the direction indicated by the arrow F in FIG. 16. FIG. 17B is a diagram showing the light source unit 51Y viewed in the direction indicated by the arrow G in FIG. 16. To clearly show the structure, FIG. 16 shows a cross-sectional view in which a wall part 201 and a sealing member 202 are cut along a plane that passes the optical axis AY and is perpendicular to the Z axis.

As shown in FIG. 16 and FIGS. 17A and 17B, a cylindrical wall part (rib) 201 is disposed on the external surface of the side wall 50b so as to completely surround the through-hole 50m provided in the side wall 50b. The vertical part 63b of the first holder 63 is located inside the cylindrical wall part 201 so as to be covered with the wall part 201.

A sealing member 202 is inserted between the inner surface of the cylindrical wall part 201 and the outer circumferential surface of the vertical part 63b (i.e. the surface facing the inner surface of the wall part 201) so as to be in close contact with both surfaces. Thus, the sealing member 202 fills the gap between the wall part 201 and the vertical part 63b. No sealing member is provided between the vertical part 63b and the side wall 50b.

The wall part 201 having a ring-like shape is provided on the side wall 50b so as to completely surround the optical axis, and the vertical part 63b of the first holder 63 is attached to the wall part 201 via the sealing member 202 so as to be surrounded by the wall part 201. Therefore, external dust and the likes are prevented from entering into the device housing from the through-hole 50m provided in the side wall 50b. If there is almost no possibility that dust and the likes enter into the device housing 50, or if entered dust and the likes do not deteriorate the image quality, the sealing member may be omitted.

Although the description above is made only on the light source unit 51Y, the other light source units 51M-51K have the same structure. Hence, explanations of the light source units 51M-51K are omitted.

Modifications

The present invention is described above based on the embodiment. However, the present invention is not limited to the embodiment as a matter of course. The following are possible modifications.

(1) In the Embodiment above, the base 50a has a step between the first bottom part 50c and the second bottom part 50d. However, such a structure is not essential. For example, the base 50a may be flat, and optical elements, such as the light source units, the deflector and the scanning lens, may be arranged on the same surface of the flat base 50a.

Also, although the semiconductor laser 61 and the collimator lens 62a in the Embodiment above are held by the first holder 63 which is held by the base 50a of the device housing, such a structure is not essential. For example, the collimator lens may be fixed to the device housing by a different member than the first holder 63. Also, although the first holder 63 and the second holder 64 in the Embodiment above are separate members and are fixed with screws, they may be integrated and realized as a single holder, which holds at least the semiconductor laser (light-emitting element) and is held by the base 50a. Such a single holder may be provided with a holder part for holding the semiconductor laser, and the holder part may be configured to enable the alignment.

If the alignment process and the focus adjustment are unnecessary due to a specific structure of the apparatus, it is acceptable that the semiconductor laser 61 is not movable in the direction perpendicular to the optical axis, and the collimator lens 62a is not movable in the optical axis direction.

(2) In the Embodiment above, the outer circumferential surface of the horizontal part 63a of the first holder 63 has a cross-section in the shape of an arc, and a V-shaped groove is provided in a surface of the second bottom part 50d, the surface facing the horizontal part 63a of the first holder 63. However, the V-shaped groove may be provided in the horizontal part 63a, and the second bottom part 50d may have a cross-section in the shape of an arc. The same applies to the support mechanism between the lens barrel 62b and the first holder 63.

The horizontal part 63a of the first holder 63 and the lens barrel 62b of the collimator lens 62a in the Embodiment above are supported at two points by the second bottom part 50d and the horizontal part 63a, respectively. However, such two point support is not essential.

Any structures are acceptable as long as the first holder 63 is held to be rotatable about the optical axis with reference to the second bottom part 50d and the lens barrel 62b is held to be movable along the optical axis with reference to the first holder 63.

For example, both the outer circumferential surface of the first holder 63 and the groove 50g of the second bottom part 50d may be configured to have a cross-section in the shape of an arc with roughly the same curvature so that the outer circumferential surface of the first holder 63 and the inner surface of the groove 50g of the second bottom part 50d are in plane-to-plane contact. The same applies to the support mechanism between the lens barrel 62b and the first holder 63.

(3) In the Embodiment above, as structures for restricting the first holder 63 from moving in the optical axis direction with respect to the device housing 50 and allowing the first holder 63 to rotate about the optical axis, the slots 63f and 63g extending in the direction perpendicular to the optical axis are provided in the protruding parts 63q and 63r of the first holder 63, respectively, and the second bottom part 50d is provided with the pins 81 and 82 protruding perpendicular to the second bottom part 50d, so that the pins 81 and 82 fit into the slots 63f and 63g. However, this is not essential. For example, as the restricting member, the external edges of the slots 63f and 63g may be open and form a notch having a U-shape in plan view. Also, the pins may be provided on the first holder, and the slots may be provided in the base.

(4) In the Embodiment above, the attachment, adjustment, etc. of the semiconductor laser 61 are made easy by providing the horizontal part 63a of the first holder 63 so as to penetrate the through-hole 50m of the side wall 50b, and providing the semiconductor laser 61 so as to be outside the device housing 50 with respect to the side wall 50b. However, such a structure is not essential. Depending on the structure of the apparatus, the light source units 51Y-51K may be housed in the device housing 50. If this is the case, the through-hole 50m needs not to be provided in the side wall 50b. All the optical elements including the light source units 51Y-51K are provided inside the device housing 50 so as to be surrounded by the side wall 50b, and the sealing members 66 and 202 and the wall part 201 will be unnecessary.

(5) The embodiments above are examples in which the optical scanning device pertaining to the present invention is adopted in a tandem color digital printer. However, the present invention is not limited to this. The present invention is applicable to both color and monochrome image formation apparatuses. Also, the number of laser beams emitted from a single semiconductor laser is not limited to two, and more than two laser beams may be emitted. Furthermore, the light-emitting element is not limited to semiconductor laser. Other types of light-emitting elements that are capable of emitting a light beam suitable for exposing an image carrier such as photosensitive drum may be used.

In other words, any optical scanning device and image formation apparatuses having the optical scanning device are applicable to, for example, copiers, FAX machines, MFPs (Multiple Function Peripherals), as long as the optical scanning device has a structure in which a plurality of optical beams are deflect by a deflector and a same image carrier is exposed and scanned over in the horizontal scanning direction by using the plurality of optical beams after the deflection simultaneously so that an electrostatic latent image is formed on the same image carrier. As the image carrier, a belt-like member may be used instead of the photosensitive drum.

The present invention may be any combinations of the Embodiment and modifications described above.

<Summary>

The Embodiment above and Modifications described above show one aspect of the present invention which solves the problems described in the RELATED ART section. The Embodiment and the Modifications can be summarized as follows.

One aspect of the present invention is an optical scanning device in which a plurality of optical beams from a light-emitting element are passed through a collimator lens, are thereby collimated, and are then deflected by a deflector, and which scans over an image carrier of an image formation apparatus by using the plurality of deflected optical beams, the optical scanning device comprising: a device housing; and a holder supported on a base of the device housing so as to be rotatable about an optical axis of the collimator lens, and penetrating through a through-hole in a side wall of the device housing in a direction along the optical axis without contacting the side wall, wherein the holder includes a first holder part and a second holder part, the first holder part being located inside the device housing with respect to the side wall, and the second holder part being located outside the device housing with respect to the side wall, the collimator lens is held by the first holder part, and the light-emitting element is held by the second holder part, and the optical beams from the light-emitting element pass through the through-hole in the side wall, and reach the collimator lens.

The optical scanning device may further comprise: a cylindrical lens provided between the collimator lens and the deflector on light paths of the optical beams from the light-emitting element to the deflector, and transmitting and condensing the optical beams in a vertical scanning direction, wherein the cylindrical lens is supported on the device housing via a supporting member other than the holder.

The holder may include: a first part that is elongated along the optical axis, penetrates through the through-hole in the side wall, and is supported on the base; and a second part that extends from a portion of the first part, the portion being located outside the device housing with respect to the side wall, and the second part extending away from the base along the side wall, and the first holder part may be provided on another portion of the first part, the other portion being located inside the device housing with respect to the side wall, and the second holder part may be provided on the second part.

The optical scanning device may further comprise: a sealing member inserted between, and thereby filling a gap between, the second part and a portion around an opening of the through hole on an outer surface of the side wall.

The optical scanning device may further comprise: a cylindrical wall part provided on an outer surface of the side wall so as to surround an opening of the through-hole; and a sealing member, wherein the second part may be located inside the cylindrical wall part so as to be covered with the cylindrical wall part, and the sealing member maybe inserted between, and thereby fill a gap between, an inner surface of the cylindrical wall part and a surface of the second part, the surface facing the inner surface of the cylindrical wall part.

The second holder part may be supported on the second part such that the light-emitting element is movable in a direction perpendicular to the optical axis.

The holder may be supported at two points on the base of the device housing.

A side of the holder facing the base may be provided with a bottom part having an arc-shaped cross-section in a plane perpendicular to the optical axis, a side of the base facing the holder may be provided with a groove having a V-shaped cross-section and extending in the direction along the optical axis, and the bottom part of the holder may fit into the groove in order to support the holder at two points on the base.

The optical scanning device may further comprise: a restricting member restricting the holder from moving in the direction along the optical axis with reference to the base.

The restricting member may be composed of a pin and an opening that is a slot or a notch, the pin being provided on one of the holder and the base, and the opening being provided in the other one of the holder and the base, the opening may extend in a direction perpendicular to the optical axis, and sizes of the pin and the opening may be defined such that when the pin fits into the opening, the holder is restricted from moving in the direction along the optical axis and is rotatable about the optical axis.

The optical scanning device may further comprise: a lens barrel configured to hold the collimator lens, wherein the collimator lens may be supported by the holder via the lens barrel so as to be movable along the optical axis direction.

A portion of the holder that supports the lens barrel may be provided with a groove having a V-shaped cross-section in a plane perpendicular to the optical axis and extending in the direction along the optical axis, and the lens barrel may fit into the groove and is supported at two points in the groove.

The optical scanning device may further comprise: a driver board provided outside the device housing, and providing power to the light-emitting element and controlling light emission timing and a light amount of the light-emitting element; and one or more supporting members attached to the base of the device housing, and supporting the driver board and thereby fixing the driver board to the device housing.

Another aspect of the present invention is an image formation apparatus having the optical scanning device defined above.

As described above, the holder holding the light-emitting element is supported on the base of the device housing, and thus the holder is not affect by the inclination of the side wall of the device housing due to environmental changes. Unlike conventional structures in which the holder is supported on the side wall, the structure of the present invention moderates image deterioration due to fluctuations in the beam pitch, on the image carrier, of the plurality of optical beams.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An optical scanning device in which a plurality of optical beams from a light-emitting element are passed through a collimator lens, are thereby collimated, and are then deflected by a deflector, and which scans over an image carrier of an image formation apparatus by using the plurality of deflected optical beams, the optical scanning device comprising:
a device housing; and
a holder supported on a base of the device housing so as to be rotatable about an optical axis of the collimator lens, and penetrating through a through-hole in a side wall of the device housing in a direction along the optical axis without contacting the side wall, wherein
the holder includes a first holder part and a second holder part, the first holder part being located inside the device housing with respect to the side wall, and the second holder part being located outside the device housing with respect to the side wall,
the collimator lens is held by the first holder part, and the light-emitting element is held by the second holder part, and
the optical beams from the light-emitting element pass through the through-hole in the side wall, and reach the collimator lens.

2. The optical scanning device of claim 1 further comprising:
a cylindrical lens provided between the collimator lens and the deflector on light paths of the optical beams from the light-emitting element to the deflector, and transmitting and condensing the optical beams in a vertical scanning direction, wherein
the cylindrical lens is supported on the device housing via a supporting member other than the holder.

3. The optical scanning device of claim 1, wherein
the holder includes:
a first part that is elongated along the optical axis, penetrates through the through-hole in the side wall, and is supported on the base; and
a second part that extends from a portion of the first part, the portion being located outside the device housing with respect to the side wall, and the second part extending away from the base along the side wall, and
the first holder part is provided on another portion of the first part, the other portion being located inside the device housing with respect to the side wall, and the second holder part is provided on the second part.

4. The optical scanning device of claim 3 further comprising:
a sealing member inserted between, and thereby filling a gap between, the second part and a portion around an opening of the through hole on an outer surface of the side wall.

5. The optical scanning device of claim 3 further comprising:
a cylindrical wall part provided on an outer surface of the side wall so as to surround an opening of the through-hole; and
a sealing member, wherein
the second part is located inside the cylindrical wall part so as to be covered with the cylindrical wall part, and
the sealing member is inserted between, and thereby fills a gap between, an inner surface of the cylindrical wall part and a surface of the second part, the surface facing the inner surface of the cylindrical wall part.

6. The optical scanning device of claim 3, wherein
the second holder part is supported on the second part such that the light-emitting element is movable in a direction perpendicular to the optical axis.

7. The optical scanning device of claim 1, wherein
the holder is supported at two points on the base of the device housing.

8. The optical scanning device of claim 7, wherein
a side of the holder facing the base is provided with a bottom part having an arc-shaped cross-section in a plane perpendicular to the optical axis,
a side of the base facing the holder is provided with a groove having a V-shaped cross-section and extending in the direction along the optical axis, and
the bottom part of the holder fits into the groove in order to support the holder at two points on the base.

9. The optical scanning device of claim 1 further comprising:
a restricting member restricting the holder from moving in the direction along the optical axis with reference to the base.

10. The optical scanning device of claim 9, wherein
the restricting member is composed of a pin and an opening that is a slot or a notch, the pin being provided on one of the holder and the base, and the opening being provided in the other one of the holder and the base,
the opening extends in a direction perpendicular to the optical axis, and
sizes of the pin and the opening are defined such that when the pin fits into the opening, the holder is restricted from moving in the direction along the optical axis and is rotatable about the optical axis.

11. The optical scanning device of claim 1 further comprising:
a lens barrel configured to hold the collimator lens, wherein
the collimator lens is supported by the holder via the lens barrel so as to be movable along the optical axis direction.

12. The optical scanning device of claim 11, wherein
a portion of the holder that supports the lens barrel is provided with a groove having a V-shaped cross-section in a plane perpendicular to the optical axis and extending in the direction along the optical axis, and
the lens barrel fits into the groove and is supported at two points in the groove.

13. The optical scanning device of claim 1 further comprising:
a driver board provided outside the device housing, and providing power to the light-emitting element and controlling light emission timing and a light amount of the light-emitting element; and
one or more supporting members attached to the base of the device housing, and supporting the driver board and thereby fixing the driver board to the device housing.

14. An image formation apparatus having the optical scanning device defined in claim 1.
